(19) United States
(12) Patent Application Publication
(10) Pub. No.: US 2026/0307730 A1
(43) Pub. Date: Oct. 8, 2026

(54) ROOF STRUCTURE FOR VEHICLE

(71) Applicants: Hyundai Motor Company, Seoul (KR); Kia Corporation, Seoul (KR)

(72) Inventors: Hoyeon Kim, Hwaseong-si (KR); Dong Wook Kim, Hwaseong-si (KR); Byeongkyu Kwon, Hwaseong-si (KR); Chulhee Heo, Hwaseong-si (KR); Hae Hoon Lee, Hwaseong-si (KR)

(21) Appl. No.: 19/401,261

(22) Filed: Nov. 25, 2025

(30) Foreign Application Priority Data
Apr. 2, 2025 (KR) 10-2025-0042546
Jun. 26, 2025 (KR) 10-2025-0084956

(51) Int. Cl. B62D 25/07; B62D 27/02

(52) U.S. Cl. CPC B62D 25/07; B62D 27/026

(57) ABSTRACT

A roof structure may include a main roof unit as a fixed element including a main roof panel, an extension roof unit as a variable element that is connected to a rear of the main roof unit along the vehicle body front-back direction and includes an extension roof panel, and a roof module mounting portion at the rear of the main roof panel.

### CROSS-REFERENCE TO RELATED APPLICATION

This application claims priority to and the benefit of Korean Patent Application No. 10-2025-0042546 filed with the Korean Intellectual Property Office on Apr. 2, 2025, and Korean Patent Application No. 10-2025-0084956 filed with the Korean Intellectual Property Office on Jun. 26, 2025, the entire contents of which are incorporated herein by reference.

### TECHNICAL FIELD

The present disclosure relates to a roof structure applicable to the production of various vehicle bodies.

### BACKGROUND

Recently, the vehicle industry has been introducing a new concept of future mobility vision for realizing a dynamic, human-centered future city. One of these future mobility solutions is a purpose-based mobility (Purpose Built Vehicle (PBV)).

PBV is an example of an electric vehicle (EV)-based environment-friendly mobility vehicle. These PBVs can provide users with a variety of customized services during their travel from departure to destination.

PBV can be manufactured in various shapes and sizes depending on the user's use case. For example, PBV can be used as a hailing or delivery type (or cargo type) vehicle.

PBV applies large-area roof panels to various vehicle types to provide users with a wide vehicle interior space according to their various use cases.

However, since these roof structures are manufactured as dedicated structures to fit various vehicle types, the development period for press molds or roll forming molds for forming roof panels is long, and investment costs such as development costs may also be increased.

Therefore, there is a need for the development of a roof structure that can be applied to vehicle bodies of different specifications according to the user's various use cases and that allows for combination production by specification through common use of molds and parts.

The information contained in this background section is intended to enhance understanding of the background of the present disclosure and may include matters that are not conventional art already publicly known, available, or in use.

### SUMMARY

The disclosed example embodiments relate to a vehicle body, and more particularly, the present disclosure relates to a roof structure applicable to the production of various vehicle bodies.

Some embodiments of the present disclosure may provide a roof structure that can secure body expandability according to various use cases and enhance roof strength and drain performance.

A roof structure according to some disclosed embodiments may include: a main roof unit as a fixed element including a main roof panel; an extension roof unit as a variable element that is connected to the rear of the main roof unit along the vehicle body front-back direction and includes an extension roof panel; and a roof module mounting forming part formed at the rear of the main roof panel.

The roof module mounting forming part may be formed in a concave shape on the rear of the main roof panel to mount a roof module including an antenna.

The roof structure may further include a drain path provided at a connection between the main roof panel and the extension roof panel.

The drain path may include a main drain flange section formed in a downward step from the rear end of the main roof panel, and an extension drain flange section formed in a downward step from the front end of the extension roof panel and connected to the main drain flange section.

The main drain flange section may be connected to the roof module mounting forming part formed at the rear of the main roof panel.

The main drain flange section and the extension drain flange section may be formed along the vehicle width direction.

The main drain flange section and the extension drain flange section may overlap in the vertical direction and be connected by welding.

The roof module mounting forming part may include a mounting surface formed to support a roof module including an antenna, and a slope surface connected to the mounting surface and sloping downward toward the drain path.

The extension roof unit may include at least one drain guide forming part formed at the front part of the extension roof panel and connected to the drain path.

The main roof unit may include a main roof rail assembly connected to the lower portion of the main roof panel.

The extension roof unit may include an extension roof rail assembly connected to the lower portion of the extension roof panel.

The main roof rail assembly may be connected to the drain path.

The main roof rail assembly may include a bridge roof rail connected along the vehicle width direction to the rear lower portion of the main roof panel and connected to the drain path.

The main roof rail assembly may include main transverse direction roof rails connected along the vehicle width direction to the lower portion of the main roof panel, a bridge roof rail connected along the vehicle width direction to the rear lower portion of the main roof panel and connected to the drain path, and main longitudinal direction roof rails connected to the main transverse direction roof rails and the bridge roof rail along the vehicle body front-back direction and connected to the lower portion of the main roof panel.

The extension roof rail assembly may include an extension transverse direction roof rail connected to the lower portion of the extension roof panel, and extension longitudinal direction roof rails connected to the bridge roof rail and the extension transverse direction roof rail along the vehicle body front-back direction, and connected to the lower portion of the extension roof panel.

The bridge roof rail may include a front flange formed on the front edge, and a rear flange formed at the rear edge and connected to the drain path.

The drain path may include a main drain flange section formed in a downward step from the rear end of the main roof panel, and an extension drain flange section formed in a downward step from the front end of the extension roof panel, connected to the main drain flange section, and connected to the rear flange.

The main drain flange section, the extension drain flange section, the rear flange, and the extension longitudinal direction roof rails may be connected through a 4-layer bonding portion.

The bridge roof rail may have an asymmetrical cross-section shape in which the cross-section position of the rear flange is lower than the cross-section position of the front flange.

For a roof structure according to some embodiments of the present disclosure, the roof structure can be applied to vehicle bodies of different specifications, thereby ensuring body expandability according to various use cases.

For a roof structure according to some embodiments of the present disclosure, roof strength and drainage performance can be enhanced.

Advantages that can be obtained or expected from the disclosed embodiments are disclosed directly or implicitly in the detailed description of the present disclosure. That is, various advantages expected according to the example embodiments of the present disclosure will be disclosed in the detailed description that follows.

### BRIEF DESCRIPTION OF THE DRAWINGS

The drawings are intended for reference in describing example embodiments of the present disclosure, and therefore technical ideas of the disclosed example embodiments should not be construed as necessarily limited to the accompanying drawings.

FIG. 1 is a perspective view illustrating a roof structure according to an example embodiment.

FIG. 2 is a top plan view illustrating a roof structure according to an example embodiment.

FIG. 3 is a bottom view illustrating a roof structure according to an example embodiment.

FIG. 4 to FIG. 6 are various exploded perspective views illustrating roof structures according to some example embodiments of the present disclosure.

FIG. 7 is a perspective view illustrating a main roof rail assembly and an extension roof rail assembly configured to be applied to a roof structure according to an example embodiment.

FIG. 8 is a top plan view illustrating a main roof rail assembly and an extension roof rail assembly configured to be applied to a roof structure according to an example embodiment.

FIG. 9 is a perspective view illustrating a roof module mounting portion and a drain path applied to a roof structure according to an example embodiment.

FIG. 10 is an exploded perspective view illustrating a roof module mounting portion and a drain path applied to a roof structure according to an example embodiment.

FIG. 11 is a top plan view illustrating a roof module mounting portion and a drain path applied to a roof structure according to an example embodiment.

FIG. 12 is a cross-sectional view along line A-A of FIG. 11.

The drawings referenced above are not necessarily drawn to scale, and may be understood as presenting rather simplified representations of various features that illustrate some principles of some example embodiments. For example, certain design features of some embodiments, including specific dimensions, direction, position, and shape, may be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice embodiments of the present disclosure. As those skilled in the art may realize, the described example embodiments may be modified and combined in various different ways for other embodiments, without departing from the spirit or scopes of the present disclosure.

Terminology used herein is for the purpose of describing particular example embodiments and is not intended to necessarily limit the present disclosure. As used herein, singular forms may be intended to include the plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term “and/or” includes any and all combinations of one or more of the associated listed items.

In this specification, the term “connected” indicates a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive” or other similar terms as used herein may generally refer to passenger vehicles, sports cars, sport utility vehicles (SUVs), buses, trucks, tractors, and various commercial vehicles, including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, some example embodiments of the present disclosure will be described in detail with reference to the attached drawings.

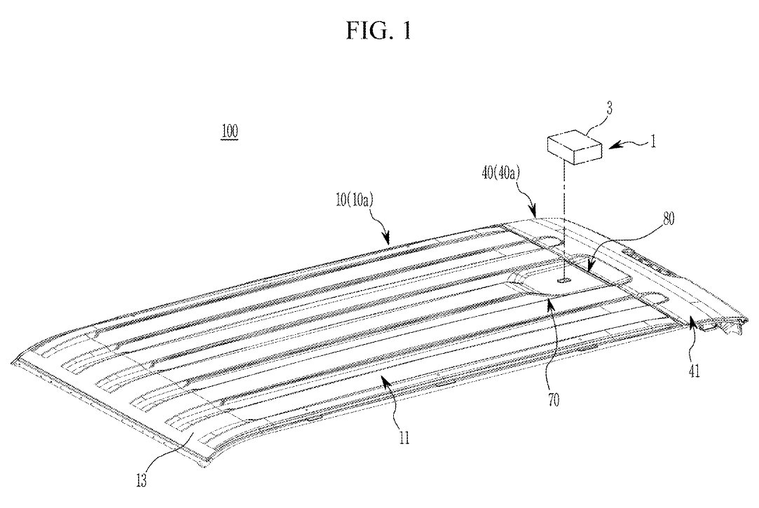

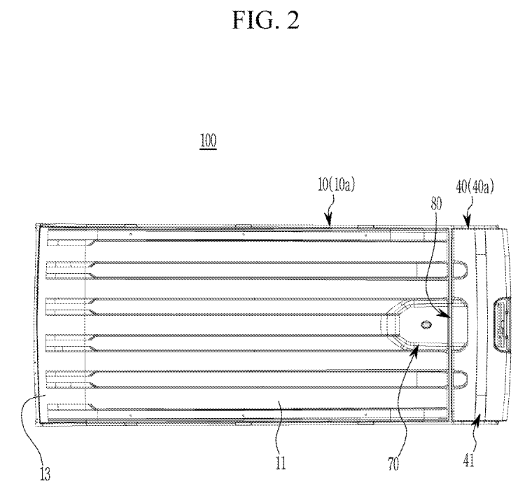

FIG. 1 is a perspective view illustrating a roof structure according to an example embodiment. FIG. 2 is a top plan view illustrating a roof structure according to an example embodiment.

Referring to FIGS. 1 and 2, a roof structure 100 according to an example embodiment may be applied to, for example, a vehicle body of a purpose-based mobility vehicle (Purpose Built Vehicle: hereinafter referred to as “PBV”).

The PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose of use of the PBV.

In this specification, the reference direction for describing the components below may be set as the vehicle body front-back direction (e.g., vehicle body length direction or longitudinal direction), vehicle width direction (e.g., lateral direction or left-right direction), and vertical direction (e.g., height direction) with the vehicle body as reference.

In this specification, the “top”, “upper”, or “upper face” of a component refers to an end, section, or face of the component that is relatively higher in the drawing, and the “bottom”, “lower”, or “lower face” of a component refers to an end, section, or face of the component that is relatively lower in the drawing.

In this specification, the term "end" of a component (e.g., one end, the other end, or both ends, etc.) refers to an end of the component in any one direction, and the term "end portion" of a component (e.g., one end portion, the other end portion, both end portions, the front end portion, or the rear end portion, etc.) refers to a portion of the component that includes that end.

The roof structure 100 according to an example embodiment may be mounted on upper portion of side structures disposed on both sides of the vehicle body, respectively.

In some embodiments, the side structure is designed to form a cabin or luggage room (or cargo room) of a wide vehicle interior space inside the vehicle body. The side structure may include doors and windows, etc., depending on the required configuration depending on the type of vehicle.

For example, in some embodiments, the side structure may be equipped with vehicle doors such as sliding doors and swing doors. In some embodiments, the side structure may be equipped with an openable window or fixed glass, or may not have a window mounted, depending on the vehicle type.

In some embodiments, the configuration of the side structure may be varied and in some examples may be apparent to those skilled in the art, so a detailed description of the side structure is omitted.

The roof structure 100 according to an example embodiment may include a roof module 1 mounted on the upper portion.

In some embodiments, the roof module 1 may include function components of various operating systems equipped in the PBV. For example, the roof module 1 may include sensors, lidar, radar, camera, and antenna. In an example embodiment, the roof module 1 may include antenna 3.

The roof structure 100 according to an example embodiment is applicable to vehicle bodies of different specifications, and provides a structure that may secure body expandability according to various use cases and secure enhanced roof strength and drain performance.

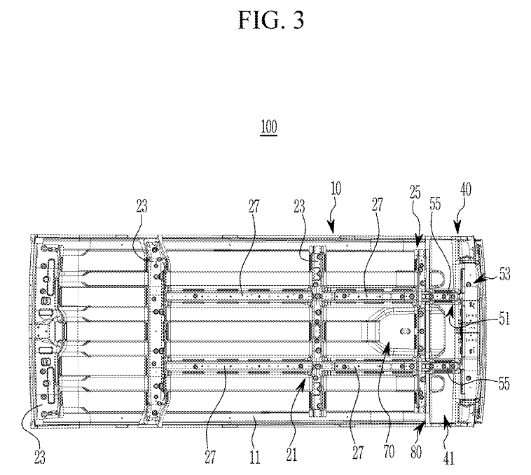

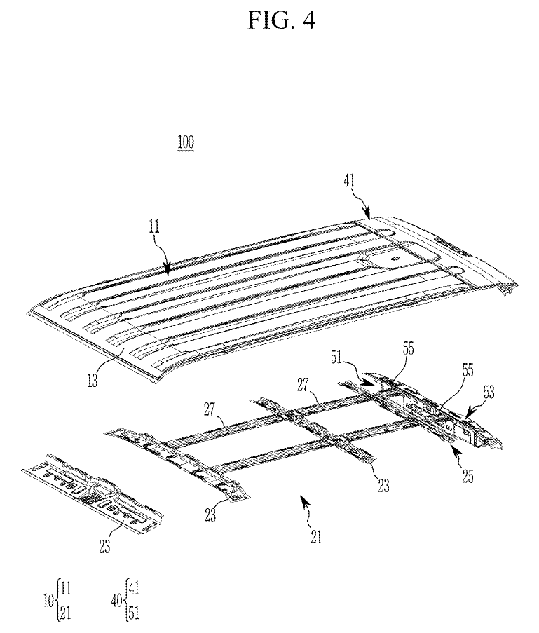

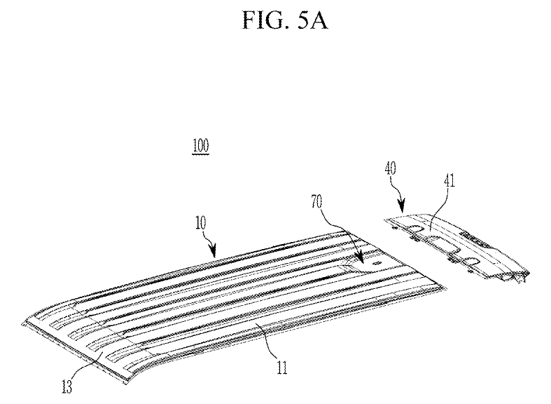

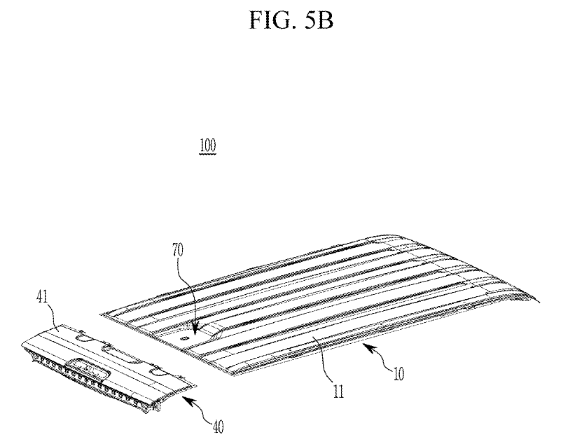

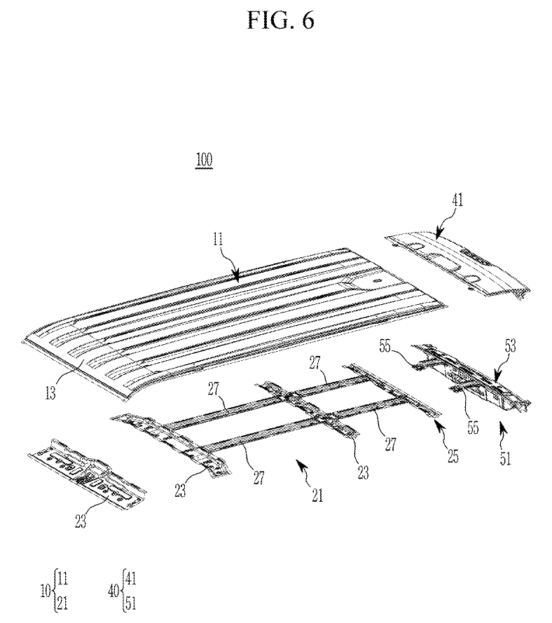

FIG. 3 is a bottom view illustrating a roof structure according to an example embodiment. FIG. 4 to FIG. 6 are various exploded perspective views illustrating roof structures according to some example embodiments.

Referring to FIG. 1 to FIG. 6, the roof structure 100 according to an example embodiment may include a main roof unit 10, an extension roof unit 40, a roof module mounting portion 70, and a drain path 80.

In an example embodiment, the main roof unit 10 may be a fixed element 10a (see FIG. 1 and FIG. 2) mounted to an upper portion of the vehicle body. In some embodiments, the fixed element 10a refers to a configuration that is not replaced even if the vehicle's intended use changes and may be commonly applied to vehicle bodies of various vehicle types.

The main roof unit 10 may include a main roof panel 11 and a main roof rail assembly 21.

The main roof panel 11 may, in one example, be provided with one panel, and in another example, may be provided with at least two panels in some embodiments. The main roof panel 11 may include a slope portion 13 that slopes downwards at the front.

The main roof rail assembly 21 may be connected to a lower portion of the main roof panel 11. The main roof rail assembly 21 may be connected to the drain path 80, which will be described below.

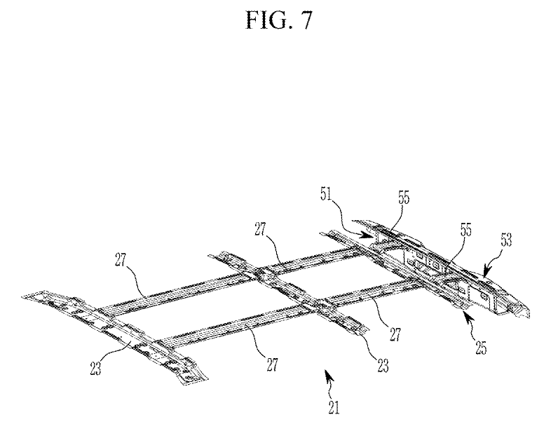

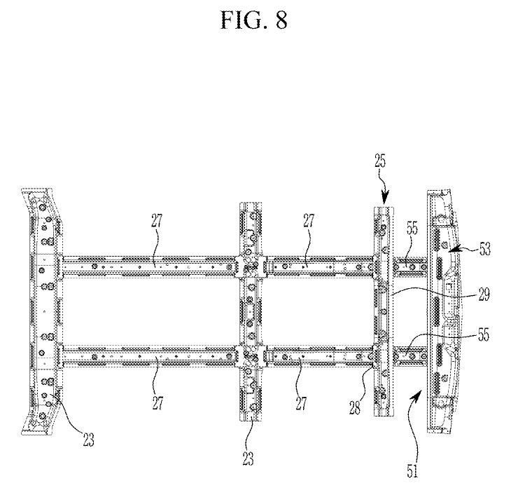

FIG. 7 is a perspective view illustrating a main roof rail assembly 21 and an extension roof rail assembly 51 configured to be applied to a roof structure according to an example embodiment. FIG. 8 is a top plan view illustrating a main roof rail assembly and an extension roof rail assembly configured to be applied to a roof structure according to an example embodiment.

Referring to FIGS. 3, 4, 6, 7 and 8, the main roof rail assembly 21 may include main transverse direction roof rails 23, a bridge roof rail 25, and main longitudinal direction roof rails 27.

In some embodiments, the main transverse direction roof rails 23 are arranged along the vehicle width direction and may be connected to the lower portion of the main roof panel 11. The main transverse direction roof rails 23 may be disposed on the front lower and middle lower portion of the main roof panel 11. Both ends of the main transverse direction roof rails 23 may be connected to the upper portion of the side structure.

In some embodiments, the main transverse direction roof rail 23, which is disposed on the middle lower portion of the main roof panel 11, may be formed into a shape formed downward from the edge portions on both sides along the front-rear direction of the vehicle body.

The bridge roof rail 25 may be connected to the rear lower portion of the main roof panel 11 along the vehicle width direction. Both ends of the bridge roof rail 25 may be connected to the upper portion of the side structure. The bridge roof rail 25 may be formed into a shape formed downward from the edge portions on both sides along the front-rear direction of the vehicle body.

The bridge roof rail 25 may be connected to the drain path 80.

The bridge roof rail 25 may include a front flange 28 formed at the front edge of the bridge roof rail 25 and a rear flange 29 formed at the rear edge of the bridge roof rail 25.

The rear flange 29 may be connected to the drain path 80. The combined structure of the bridge roof rail 25 and the drain path 80 will be described in detail below.

In some embodiments, the main longitudinal direction roof rails 27 are connected to the main transverse direction roof rails 23 and the bridge roof rail 25 along the vehicle body front-back direction, and may be connected to the lower portion of the main roof panel 11.

The main longitudinal direction roof rails 27 may be formed into a shape formed downward from both edges along the vehicle width direction. The main longitudinal direction roof rails 27 may be disposed in a spine shape of two rows, for example, along the vehicle body front-back direction.

The main longitudinal direction roof rails 27, the main transverse direction roof rails 23, and the bridge roof rail 25 may be disposed to cross in the vertical direction (or the vehicle body front-back direction and vehicle width direction).

The main longitudinal direction roof rails 27 may be disposed along the vehicle body front-back direction spaced apart from each other. The spaced ends of the main longitudinal direction roof rails 27 may be connected to the lower portions of the main transverse direction roof rails 23 and the bridge roof rail 25.

Referring to FIG. 1 to FIG. 6, in some embodiments, the extension roof unit 40 is configured to selectively extend the roof panel area of the roof structure 100 according to different specifications of the vehicle body.

The extension roof unit 40 may be a variable element (replaceable portion) 40a (see FIG. 1 and FIG. 2) connected to the rear portion of the main roof unit 10 along the vehicle body front-back direction.

In some embodiments, the variable element 40a refers to a configuration that may be replaced depending on the intended use of the vehicle and may be connected to the rear of a vehicle body of various vehicle types.

In some embodiments, the various vehicle types refer to various configurations of the variable element 40a, and may include, for example, a hailing vehicle as a means of transporting occupants, a delivery vehicle for transporting goods, and special vehicles such as ambulances.

The extension roof unit 40 may include an extension roof panel 41 and an extension roof rail assembly 51.

In some embodiments, the extension roof panel 41 is configured to extend the area of the main roof panel 11 to the rear. In some embodiments, the extension roof panel 41 is provided separately from the main roof panel 11 and may be connected to the rear of the main roof panel 11 along the vehicle body front-back direction.

The extension roof panel 41 may be provided as a roof panel of the variable element 40a, which may set the area of the overall roof panel of the roof structure 100 together with the main roof panel 11. In some embodiments, the extension roof panel 41 may be a panel having different panel areas depending on the vehicle body of various vehicle types.

The extension roof rail assembly 51 can be connected to the lower portion of the extension roof panel 41. The extension roof rail assembly 51 can be connected to the rear of the main roof rail assembly 21 along the vehicle body front-back direction.

Referring to FIGS. 3, 4, 6, 7 and 8, in some embodiments, the extension roof rail assembly 51 may include an extension transverse direction roof rail 53 and extension longitudinal direction roof rails 55.

The extension transverse direction roof rail 53 may be connected to the lower portion of the extension roof rail assembly 51 along the vehicle width direction. Both ends of the extension transverse direction roof rail 53 may be connected to the upper portion of the side structure.

In some embodiments, the extension transverse direction roof rail 53 may be provided as a roof rail assembly including, for example, a combination of at least two rail members. The at least two rail members may be press formed into a predetermined shape.

The extension longitudinal direction roof rails 55 may be connected to the bridge roof rail 25 of the main roof rail assembly 21 and the extension transverse direction roof rail 53 along the vehicle body front-back direction.

The extension longitudinal direction roof rails 55 may be connected to the lower portion of the extension roof panel 41. The extension longitudinal direction roof rails 55 may be formed into a shape formed downward from both edges along the vehicle width direction.

The extension longitudinal direction roof rails 55 may be disposed along the vehicle body front-back direction at positions corresponding to the main longitudinal direction roof rails 27 of the main roof rail assembly 21. That is, in some embodiments, the main longitudinal direction roof rails 27 and the extension longitudinal direction roof rails 55 may be disposed on the same line along the vehicle body front-back direction.

Referring to FIG. 1, in some embodiments, the roof module mounting portion 70 may be configured to mount the roof module 1 including the antenna 3 mentioned above to the main roof unit 10.

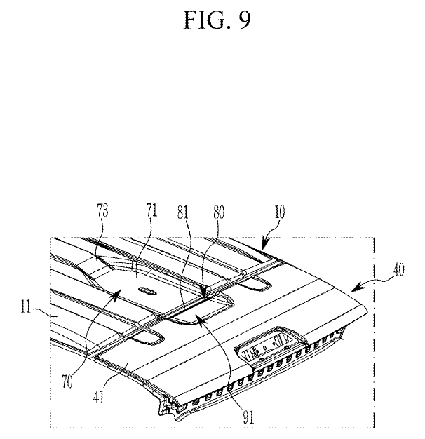

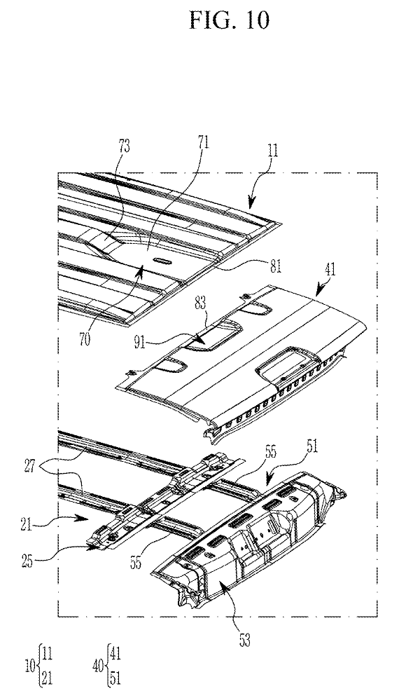

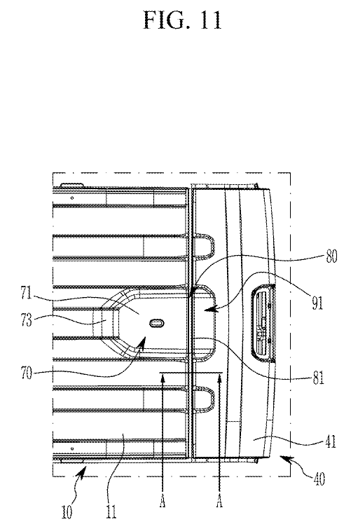

FIG. 9 is a perspective view illustrating a roof module mounting portion and a drain path applied to a roof structure according to an example embodiment. FIG. 10 is an exploded perspective view illustrating a roof module mounting portion and a drain path applied to a roof structure according to an example embodiment. FIG. 11 is a top plan view illustrating a roof module mounting portion and a drain path applied to a roof structure according to an example embodiment.

Referring to FIG. 9 to FIG. 11, the roof module mounting portion 70 according to some embodiments may be formed on the rear part of the main roof panel 11 in the main roof unit 10.

The roof module mounting portion 70 may be formed in a concave shape on the rear of the main roof panel 11. The roof module mounting portion 70 may be provided in a shape that is formed concavely downward from the upper portion surface of the main roof panel 11.

The roof module mounting portion 70 may include a mounting surface 71 and a slope surface 73.

The mounting surface 71 may be formed in a concave flat shape at the rear of the main roof panel 11 to support the roof module 1.

The slope surface 73 is connected to the mounting surface 71 at the front of the roof module mounting portion 70, and may be formed to slope downward from the front to the rear. The slope surface 73 may be formed to slope downward toward the drain path 80, which will be described below.

Referring to FIGS. 1 and 2, in some embodiments, the drain path 80 is configured to drain water and foreign substances, etc., toward the side structure by mounting the roof module 1 on the roof module mounting portion 70 of the main roof panel 11.

In some embodiments, the drain path 80 is configured to discharge the coating solution, etc., toward the side structure when passing through the paint oven during the painting process of the vehicle body.

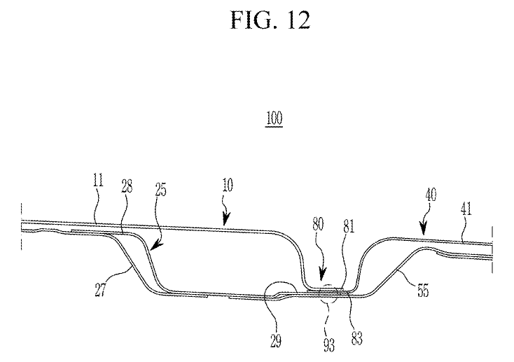

FIG. 12 is a cross-sectional view along line A-A of FIG. 11.

Referring to FIG. 9 to FIG. 12, the drain path 80 according to some embodiments may be provided between the main roof unit 10 and the extension roof unit 40. The drain path 80 may be disposed at the connection between the main roof panel 11 and the extension roof panel 41.

The drain path 80 may include a main drain flange section 81 and an extension drain flange section 83.

The main drain flange section 81 may be formed in the form of a flange at the rear end of the main roof panel 11. The main drain flange section 81 may be formed in a downward step along the vehicle width direction from the rear end of the main roof panel 11.

The extension drain flange section 83 may be formed in the form of a flange at the front end of the extension roof panel 41 at a position corresponding to the main drain flange section 81.

The extension drain flange section 83 may be formed in a downward step along the vehicle width direction from the front end of the extension roof panel 41. The extension drain flange section 83 may be connected to the main drain flange section 81.

The main drain flange section 81 and the extension drain flange section 83 may be formed in a straight line shape along the vehicle width direction. In some embodiments, the main drain flange section 81 and the extension drain flange section 83 overlap in the vertical direction and may be connected by welding.

In some embodiments, as the main drain flange section 81 and the extension drain flange section 83 are interconnected, the drain path 80 may be formed in a groove shape along the vehicle width direction at the connection portion of the main roof panel 11 and the extension roof panel 41.

The main drain flange section 81 may be connected to the mounting surface 71 of the roof module mounting portion 70.

The extension roof unit 40 may include at least one drain guide portion 91 formed at the front portion of the extension roof panel 41.

The at least one drain guide portion 91 may be formed at a position corresponding to the mounting surface 71 of the roof module mounting portion 70. The at least one drain guide portion 91 may be formed as a slope surface sloping downward from the rear to the front.

The at least one drain guide portion 91 may be connected to the extension drain flange section 83. That is, in some embodiments, the at least one drain guide portion 91 may be connected to the drain path 80. The at least one drain guide portion 91 may direct water such as rainwater to the drain path 80.

In the drain path 80, the extension drain flange section 83 connected to the main drain flange section 81 may be connected to the bridge roof rail 25 of the main roof rail assembly 21.

The extension drain flange section 83 may be connected to the rear flange 29 of the bridge roof rail 25.

The main drain flange section 81, the extension drain flange section 83, the rear flange 29 of the bridge roof rail 25, and the extension longitudinal direction roof rails 55 may be connected along the vertical direction via the 4-layer bonding portion 93, as shown in FIG. 12.

The bridge roof rail 25 may be provided with an asymmetrical cross-section shape in which the cross-section position of the rear flange 29 is lower than the cross-section position of the front flange 28.

An assembly process and operation of the roof structure 100 according to an example embodiment will be described in detail referring to FIG. 1 to FIG. 12.

In an example embodiment, the main roof unit 10 may be provided including the main roof panel 11, the main transverse direction roof rails 23, the bridge roof rail 25, and the main longitudinal direction roof rails 27.

In an example embodiment, the extension roof unit 40 may be provided including the extension roof panel 41, the extension transverse direction roof rail 53, and the extension longitudinal direction roof rails 55.

A process may be performed to attach the main transverse direction roof rails 23, the bridge roof rail 25, and the extension transverse direction roof rail 53 to the upper portion of the side structure along the vehicle width direction.

A process may be performed to join the main longitudinal direction roof rails 27 to the main transverse direction roof rails 23 and the bridge roof rail 25 along the vehicle body front-back direction. A process may be performed to connect the extension longitudinal direction roof rails 55 to the bridge roof rail 25 and the extension transverse direction roof rail 53 along the vehicle body front-back direction.

A process may be performed in which a sealer (not shown) is applied to predetermined areas of the extension transverse direction roof rail 53 and the extension longitudinal direction roof rails 55, and the extension roof panel 41 is joined to the extension transverse direction roof rail 53 and the extension longitudinal direction roof rails 55 through the sealer.

The extension drain flange section 83 formed on the extension roof panel 41 may be disposed on the rear flange 29 of the bridge roof rail 25. The extension drain flange section 83 and the rear flange 29 may be connected by welding along the vehicle width direction.

A process may be performed in which a sealer (not shown) is applied to predetermined areas of the main transverse direction roof rails 23, the bridge roof rail 25, and the main longitudinal direction roof rails 27, and the main roof panel 11 is joined to the main transverse direction roof rails 23, the bridge roof rail 25, and the main longitudinal direction roof rails 27 via the sealer.

In the above example process flow, the main drain flange section 81 formed on the main roof panel 11 may be disposed on the extension drain flange section 83. The main drain flange section 81 and the extension drain flange section 83 may be connected by welding along the vehicle width direction.

Therefore, the main drain flange section 81, the extension drain flange section 83 and the rear flange 29 of the bridge roof rail 25 may be connected by welding along the vertical direction.

Between the main roof unit 10 and the extension roof unit 40, the drain path 80 may be formed at the connection between the main roof panel 11 and the extension roof panel 41.

The roof module mounting portion 70 formed on the main roof panel 11 and at least one drain guide portion 91 formed on the extension roof panel 41 may be disposed along the vehicle body front-back direction with the drain path 80 between them.

A process of mounting roof module 1 on the roof module mounting portion 70 may be performed.

In the process, the roof module 1 may be mounted on the mounting surface 71 of the roof module mounting portion 70, for example via a mounting bracket (not shown). The mounting bracket may be engaged to the mounting surface 71 by a fastening member including a bolt and a nut.

The process described so far may be performed as a process for assembling the roof structure 100 on the upper portion of a vehicle body in a vehicle body assembly line. However, without being limited thereto, a process of mounting the roof structure 100 assembled separately in a roof assemble line onto an upper portion of a vehicle body in a vehicle body assemble line may also be performed.

According to the roof structure 100 assembled through the processes described above, the main roof unit 10 may be disposed of as the fixed element 10a that is not replaced even if the vehicle's intended use changes. In some embodiments, the extension roof unit 40 is connected to the main roof unit 10 along the vehicle body front-back direction and may be provided as the variable element 40a that may be replaced depending on the vehicle's intended use.

Accordingly, the roof structure 100 according to some embodiments may be applied to vehicle bodies of various specifications according to various use cases of users. The roof structure 100 according to an example embodiment may selectively expand the overall roof panel area according to vehicle bodies of different specifications.

According to the roof structure 100 according to some embodiments, body expandability according to various use cases may be secured.

According to the roof structure 100 according to some embodiments, through common use of molds and parts, combined production according to the specifications of the vehicle body is possible, and the development period and investment cost of the mold for forming the roof panel may be reduced.

According to the roof structure 100 according to some embodiments, the roof rails may provide the main roof rail assembly 21 and the extension roof rail assembly 51 connected along the vehicle width direction and the vehicle body front-back direction, respectively.

According to the roof structure 100 according to some embodiments, the connection between the main roof rail assembly 21 and the extension roof rail assembly 51 may be strengthened.

According to the roof structure 100 according to some embodiments, the joint strength of the main roof rail assembly 21 and the main roof panel 11, and the joint strength of the extension roof rail assembly 51 and the extension roof panel 41 may be strengthened.

According to the roof structure 100 according to some embodiments, enhanced roof strength may be secured and problems such as sagging of the main roof rail assembly 21 and the extension roof rail assembly 51 may be suppressed.

According to the roof structure 100 according to some embodiments, the roof module mounting portion 70 is formed on the main roof panel 11 of the main roof unit 10, and the roof module 1 including the antenna 3, for example, may be mounted on the roof module mounting portion 70.

According to the roof structure 100 according to some embodiments, at least one drain guide portion 91 may be formed in the extension roof panel 41 of the extension roof unit 40.

According to the roof structure 100 according to some embodiments, the drain path 80 may be formed between the main roof unit 10 and the extension roof unit 40, at the connection portion of the main roof panel 11 and the extension roof panel 41.

According to the roof structure 100 according to some embodiments, water such as rainwater that has inflowed into the roof module mounting portion 70 and at least one drain guide portion 91 may be discharged toward the side structure through the drain path 80.

The roof structure 100 according to some embodiments may secure enhanced drain performance and minimize damage to the roof module 1 caused by water or foreign substances.

While the present disclosure has been described in connection with what is presently considered to be some practical example embodiments, it may be understood that the present disclosure is not necessarily limited to the disclosed example embodiments. On the contrary, the present disclosure is intended to cover various modifications and equivalent arrangements included within the spirit and scopes of the appended claims and equivalents thereof.

What is claimed is:

1. A roof structure comprising:
a main roof unit as a fixed element including a main roof panel;
an extension roof unit as a variable element that is connected to a rear of the main roof unit along a vehicle body front-back direction and includes an extension roof panel; and
a roof module mounting portion at the rear of the main roof panel.

2. The roof structure of claim 1, wherein the roof module mounting portion includes a concave shape on the rear of the main roof panel configured to mount a roof module including an antenna.

3. The roof structure of claim 1, further comprising a drain path disposed at a connection between the main roof panel and the extension roof panel.

4. The roof structure of claim 3, wherein the drain path comprises:
a main drain flange section extending in a first downward step from a rear end of the main roof panel; and
an extension drain flange section extending in a second downward step from a front end of the extension roof panel and connected to the main drain flange section.

5. The roof structure of claim 4, wherein the main drain flange section is fluidly connected to the roof module mounting portion.

6. The roof structure of claim 4, wherein the main drain flange section and the extension drain flange section are disposed along a vehicle width direction.

7. The roof structure of claim 6, wherein the main drain flange section and the extension drain flange section overlap each other in a vertical direction and are weldedly connected to each other.

8. The roof structure of claim 3, wherein the roof module mounting portion comprises:
a mounting surface configured to support a roof module including an antenna; and
a slope surface connected to the mounting surface and sloping downward toward the drain path.

9. The roof structure of claim 8, wherein the extension roof unit comprises at least one drain guide portion formed at a front part of the extension roof panel and fluidly connected to the drain path.

10. The roof structure of claim 3, wherein:
the main roof unit includes a main roof rail assembly connected to a lower portion of the main roof panel; and
the extension roof unit includes an extension roof rail assembly connected to a lower portion of the extension roof panel.

11. The roof structure of claim 10, wherein the main roof rail assembly is connected to the drain path.

12. The roof structure of claim 10, wherein the main roof rail assembly comprises a bridge roof rail connected along a vehicle width direction to a rear lower portion of the main roof panel and connected to the drain path.

13. The roof structure of claim 10, wherein the main roof rail assembly comprises:
main transverse direction roof rails connected along a vehicle width direction to the lower portion of the main roof panel;
a bridge roof rail connected along the vehicle width direction to a rear lower portion of the main roof panel and connected to the drain path; and
main longitudinal direction roof rails connected to the main transverse direction roof rails and the bridge roof rail along the vehicle body front-back direction and connected to the lower portion of the main roof panel.

14. The roof structure of claim 13, wherein the extension roof rail assembly comprises:
an extension transverse direction roof rail connected to the lower portion of the extension roof panel; and
extension longitudinal direction roof rails connected to the bridge roof rail and the extension transverse direction roof rail along the vehicle body front-back direction, and connected to the lower portion of the extension roof panel.

15. The roof structure of claim 12, wherein the bridge roof rail comprises:
a front flange extending on a front edge; and
a rear flange extending at a rear edge and connected to the drain path.

16. The roof structure of claim 15, wherein the drain path comprises:
a main drain flange section extending in a first downward step from a rear end of the main roof panel; and
an extension drain flange section extending in a second downward step from a front end of the extension roof panel, connected to the main drain flange section, and connected to the rear flange.

17. The roof structure of claim 16, wherein the main drain flange section, the extension drain flange section, the rear flange, and extension longitudinal direction roof rails are connected through a 4-layer bonding portion.

18. The roof structure of claim 15, wherein the bridge roof rail has an asymmetrical cross-section shape in which a first cross-section position of the rear flange is lower than a second cross-section position of the front flange.

19. A vehicle comprising a roof structure, wherein the roof structure comprises:
a main roof module as a fixed module element including a main roof panel;
an extension roof module as a variable module element that is connected to a rear of the main roof module along a vehicle body front-back direction and includes an extension roof panel;
a roof module mounting portion at the rear of the main roof panel; and
a drain path disposed at a connection between the main roof panel and the extension roof panel, wherein the drain path comprises:
a main drain flange section extending in a first downward step from a rear end of the main roof panel, wherein the main drain flange section is fluidly connected to the roof module mounting portion, and
an extension drain flange section extending in a second downward step from a front end of the extension roof panel and connected to the main drain flange section, wherein the main drain flange section and the extension drain flange section overlap each other in a vertical direction, wherein the main drain flange section and the extension drain flange section are disposed along a vehicle width direction.

20. A method of assembling a vehicle, comprising:
assembling a main roof unit including a main roof panel, main transverse direction roof rails, a bridge roof rail, and main longitudinal direction roof rails, wherein the main roof panel includes a main drain flange section recessed at a rear end of the main roof panel, wherein the main roof panel includes a roof module mounting portion at a rear end portion of the main roof panel, and wherein the assembling of the main roof unit comprises:
connecting the main longitudinal direction roof rails to the main transverse direction roof rails and the bridge roof rail along a vehicle body front-back direction, and
connecting the main roof panel to the main transverse direction roof rails, the bridge roof rail, and the main longitudinal direction roof rails;
selecting a usage type of the vehicle;
selecting and assembling an extension roof unit including an extension roof panel, an extension transverse direction roof rail, and extension longitudinal direction roof rails, based on the selecting of the usage type of the vehicle, wherein the extension roof panel includes an extension drain flange section recessed at a front edge of the extension roof panel, wherein the assembling of the extension roof unit comprises:
connecting the extension transverse direction roof rail to the extension longitudinal direction roof rails, and
connecting the extension roof panel to the extension transverse direction roof rail and the extension longitudinal direction roof rails;
overlapping and welding the main drain flange section and the extension drain flange section to form a drain path extending along a vehicle width direction, such that the roof module mounting portion is fluidly connected to the drain path;
connecting the extension longitudinal direction roof rails to the bridge roof rail and the extension transverse direction roof rail along the vehicle body front-back direction; and
attaching the main transverse direction roof rails, the bridge roof rail, and the extension transverse direction roof rail to upper portions of side structures of the vehicle.
